(19) United States
(12) Patent Application Publication
(10) Pub. No.: US 2015/0018088 A1
(43) Pub. Date: Jan. 15, 2015

(54) Method and System For Playing A Game

(71) Applicant: Tze Chuah Koh, Singapore (SG)

(72) Inventor: Tze Chuah Koh, Singapore (SG)

(21) Appl. No.: 13/938,363

(22) Filed: Jul. 10, 2013

(51) Int. Cl. A63F 13/00

(52) U.S. Cl. CPC A63F 13/00
USPC 463/29

(57) ABSTRACT

This invention provides a method for playing a game, the method comprising (a) providing at least two options to a player for the player's selection, the at least two options relate to at least two potential outcomes of an event; (b) obtaining a selection from the player; (c) issuing to the player a unique identifier, the identifier obtained from a set of identifiers representing possible values associated with the outcome of the event; and (d) comparing the outcome of the event with the player's identifier to determine if the player is the winner. A system for playing a game, and a computer-readable medium having computer-readable signals stored thereon that define instructions that, as a result of being executed by a computer, instructs the computer to perform a method for playing a game are also disclosed.

### FIELD OF THE INVENTION

This invention relates to a method and system for playing a game. In particular, the invention relates to a method and system for playing a prediction game whereby players are asked to select one of at least two options that relate to at least two potential outcomes of an event.

### BACKGROUND OF THE INVENTION

At present, prediction questions are created in betting and gaming systems where a participant answers the question (and makes a prediction) simply picks a choice from a list of choices. Such prediction questions usually form the basis of contests and lucky draws where participants who answer the question correctly may win prizes. These prediction questions usually ask a participant to predict an outcome to an event. The answer selected by the participant completes the participation process. Take the following prediction game for example:

“Prediction Question: Will Apple Stock Price close above USD500 or below USD500 on the 8 Aug. 2013? The choices are:

(a) Above USD500; or (b) Below USD500

With reference to the scenario given in the above example, a participant of the game will need to select either (a) or (b) to complete the participation process.

There are problems associated of this present method.

For example, the criteria to define the winner is either (a) or (b) above. And this can be challenging when it comes to rewarding the winners, especially in a case where there are a lot of people participating in the game and the participants are not required to pay a fee. For example, suppose the reward is a free iPhone and 2000 people participated in the game. 1500 people selected choice (a) and the other 500 people selected choice (b). And suppose choice (a) turned out to be the winning choice. In this case, it will be very costly for a sponsor to provide 1500 free iPhone since there are 1500 winners.

Hence, while it is good to have as many participants as possible to participate in the game, it can be costly when it comes to rewarding the winners. While it is possible to conduct a lucky draw to limit the winner or winners who selected the winning choice, the lucky draw itself is an additional step in selecting a winner. Such lucky draws can be another lengthy and costly manual process to organize.

Thus, there is no control put in place to control the number of participants. Further, there is no control put in place to limit the number of winner or winners.

Therefore, there is a need for an improved method and system for carrying out such prediction games.

### SUMMARY OF THE INVENTION

In accordance with a preferred aspect of the invention, there is provided a method for playing a game, the method comprising: (a) providing at least two options to a player for the player's selection, the at least two options relate to at least two potential outcomes of an event; (b) obtaining a selection from the player; and (c) issuing to the player a unique identifier, the identifier obtained from a set of identifiers representing possible values associated with the outcome of the event; and (d) comparing the outcome of the event with the player's identifier to determine if the player is the winner.

By “identifier”, it is meant to include any word, number, letter, symbol, picture or any combination of these, or the like that may be issued to a player as a means to identify that player.

Preferably, the unique identifier is randomly issued to the player.

Preferably, the identifiers are numeral in value. Preferably, the set of identifiers comprises a series of identifiers in successive order. By “successive”, it is meant that the numbers are in an uninterrupted consecutive order. More preferably, the difference between each successive identifier is 1.

Alternatively, the difference between each successive identifier is 0.1. Still alternatively, the difference between each successive identifier is 0.01 or 0.25 or 0.025.

Preferably, the identifiers are arranged in a table consisting of rows and columns.

Preferably, the method further comprising determining at least one consolation winner by comparing the identifier of the at least one consolation winner with reference to the identifier of the winner, wherein the identifier of the at least one consolation winner is proximate to the identifier of the winner in the table of identifiers.

Preferably, the events are selected from any one of the group: ongoing sporting events, political elections, and close prices of stocks. In addition, events such as the close prices of commodities, the close value of indices like Nasdaq, Dow Jones Industrial Average, FTSE, etc. may also be included.

In accordance with another preferred aspect of the invention, there is provided a system for playing a game, the system comprising: (a) a means for providing at least two options to a player for the player's selection, the at least two options relate to at least two potential outcomes of an event; (b) a means for obtaining a selection from the player; and (c) a means for issuing to the player a unique identifier, the identifier obtained from a set of identifiers representing possible values associated with the outcome of the event; and (d) a means for comparing the outcome of the event with the player's identifier to determine if the player is the winner. (e) Identifying the consolation prize winners (if any)

Preferably, the unique identifier is randomly issued to the player.

Preferably, the identifiers are numeral in value. Preferably, the set of identifiers comprises a series of identifiers in successive order. More preferably, the difference between each successive identifier is 1.

Alternatively, the difference between each successive identifier is 0.1. Still alternatively, the difference between each successive identifier is 0.01 or 0.25 or 0.025.

Preferably, the identifiers are arranged in a table consisting of rows and columns.

Preferably, the system further comprising a means for determining at least one consolation winner by comparing the identifier of the at least one consolation winner with reference to the identifier of the winner, wherein the identifier of the at least one consolation winner is proximate to the identifier of the winner in the table of identifiers.

Preferably, the events are selected from any one of the group: ongoing sporting events, political elections, and close prices of stocks. In addition, events such as the close prices of commodities, the close value of indices like Nasdaq, Dow Jones Industrial Average, FTSE, etc. may also be included.

In accordance with another preferred aspect of the invention, there is provided a computer-readable medium having computer-readable signals stored thereon that define instructions that, as a result of being executed by a computer, instructs the computer to perform a method for playing a game, the method comprising: (a) providing at least two options to a player for the player's selection, the at least two options relate to at least two potential outcomes of an event; (b) obtaining a selection from the player; and (c) issuing to the player a unique identifier, the identifier obtained from a set of identifiers representing possible values associated with the outcome of the event; and (d) comparing the outcome of the event with the player's identifier to determine if the player is the winner.

Advantageously, the present invention provides a method and system of keeping the participation process simple and at the same time control the number of participants and limit the number of winners in a prediction game, through the issuance of a unique identifier to a player where the identifier is obtained from a set of identifiers representing possible values associated with the outcome of the event and then comparing the outcome of the event with the player's identifier to determine if the player is the winner. Thus, there is no need for a further draw to determine the winner.

### BRIEF DESCRIPTION OF THE FIGURES

In order that the present invention may be fully understood and readily put into practical effect, there shall now be described by way of non-limitative examples only preferred embodiments of the present invention, the description being with reference to the accompanying illustrative figures.

In the Figures:

FIG. 1 shows a table of identifiers in accordance with an embodiment of the present invention;

FIG. 2 shows a flow chart showing a summary of the method of setting up the game in accordance with an embodiment of the present invention;

FIG. 3 shows a flow chart showing the method of setting up the identifier table in accordance with an embodiment of the present invention;

FIG. 4 shows a flow chart showing the selection of a winner of the game in accordance with an embodiment of the present invention;

FIGS. 5(a) to (f) show a table of identifier showing how consolation prize winners may be selected in accordance with an embodiment of the present invention. Triangles represent the specific winner, and circles represent the additional winners or consolation winners;

FIGS. 6(a) to (c) show pictorial summaries of an example of a game according to an embodiment of the present invention;

FIGS. 7(a) to (c) show pictorial summaries of an example of a game according to another embodiment of the present invention; and

FIGS. 8(a) to (c) show pictorial summaries of an example of a game according to yet another embodiment of the present invention.

### DETAILED DESCRIPTION OF THE PREFERRED EMBODIMENTS

In the present invention, the participation process for players of a game requires providing at least two options to a participant (or player) for his selection. These two options relate possible and potential outcomes of an event on which the player is predicting or betting upon. As such, this keeps the game simple by having the participant to simply select a choice from a small handful of choices (normally two, in this case). There may be any number of choices that may be made available to a player, for example two, three, four etc.

Each player will be provided with a unique user ID. This user ID will allow the system to identify the player and may be the player's Facebook account (or other social media accounts e.g. Twitter, Instagram, etc.), email address, mobile phone number or the like.

The system then receives and obtains the selection made from the player and the system then issues an identifier that is unique to that player. In other words, the player will have to choose one answer in those options/choices made available to him. Once he has done so, the system automatically and randomly assigned him an identifier that is unique to that entry made by the player. If the player wishes to make another selection, he can play the game multiply times, in which case, each entry (or choice made by him) will assign him a unique identifier. As such, if he has multiple entries, he will be assigned multiple identifiers—each identifier unique to each entry. The unique identifier is obtained from a set of identifiers representing possible values associated with the outcome of the event. The winner is then determined by comparing the outcome of the event with the player's identifier value. In a preferred embodiment, the identifier is automatically and randomly assigned to the participant.

The set of identifiers represent all possible values that are associated with the outcome of the event, the event being the subject of the question. For example, returning to the example question—“will Apple Stock Price closed above USD500 or below USD500 on the 8 Aug. 2013?”. The possible identifiers may be all values from USD400 to USD600. The total number of identifiers may be set and pre-determined by the game organiser or developer. If a player selects the option “below USD500”, then the system will automatically and randomly assign him an identifier from the set of identifiers that are below USD500, i.e. between USD400 to USD499. Likewise, if a player selects the option “above USD500”, then the system will automatically and randomly assign him an identifier from the set of identifiers that are above USD500, i.e. between USD501 and USD600.

The introduction of the unique identifier speeds up the process of identifying the winner or winners automatically in a prediction game (when the result is released).

In an embodiment of the present invention, the unique identifier is randomly issued to the player by the system. Preferably, any data processing module known to the skilled person will be able to carry out this function. The identifiers may be arranged in a table consisting of rows and columns. This feature allows the position of the specific winner or winners to be identified and communicated using rows and columns. Additionally, the rows and columns method of arranging the cells allow the additional patterns of further other winners (for example, consolation prize winners) to be specifically defined during the setup stage.

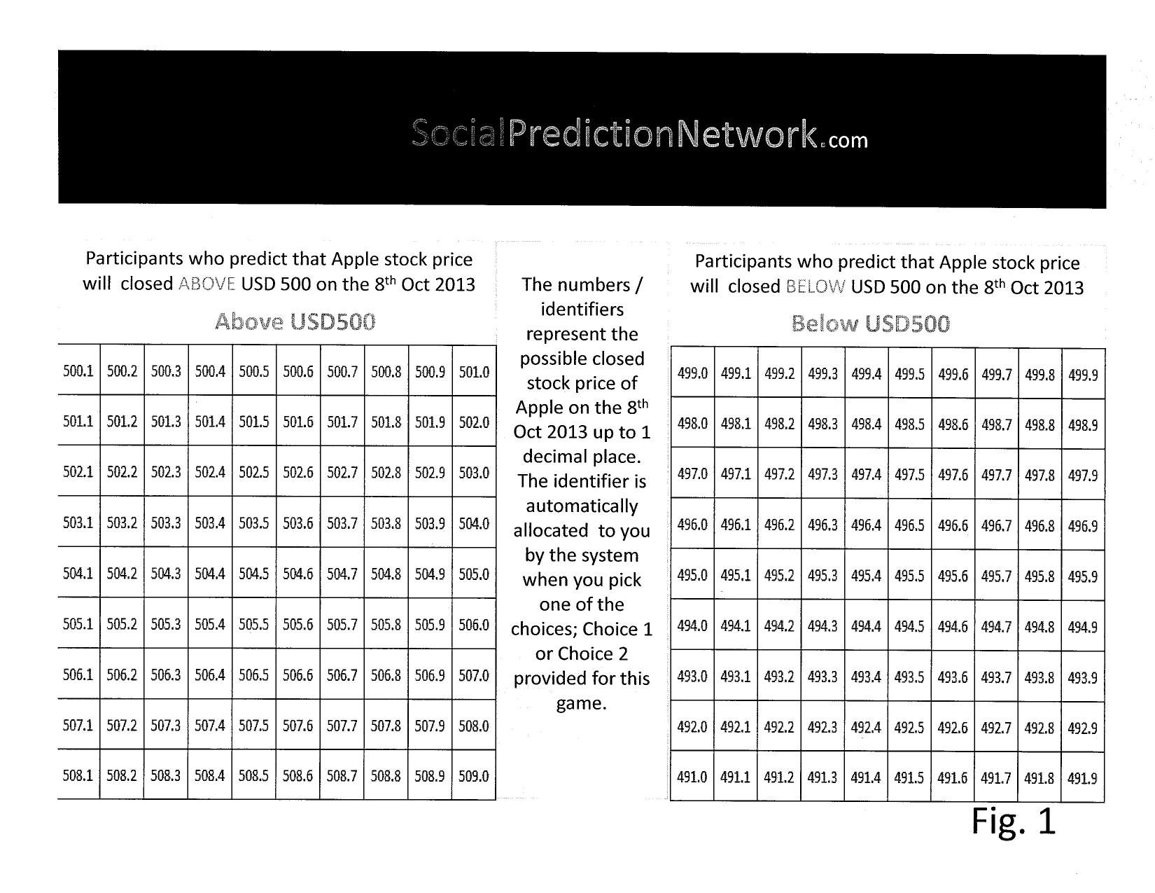

FIG. 1 shows an example of how the identifiers are arranged in rows and columns, for example in the form of a table. With reference to FIG. 1, the identifiers will be populated from the left to the right, starting from the top left-most cell. If there are too many identifiers and their numbers run into the thousands, then the rows and columns may be spread over a few pages. In the example provided in FIG. 1, a board could be made up of 10 columns×9 rows which equates to go identifiers per board. And if there are 900 identifiers allow for each choice, then there will be 900/100=10 boards needed to display the identifiers. If one page displays a board, then 10 pages will be needed to display 10 boards. The “row and column” arrangement allows for the quick identification of the winner and/or consolation prize winners. This will be described in greater detail below.

The winner of the game/contest is identified once the outcome of the event is known. This is done by comparing the outcome of the event with the player's identifier to determine if he wins the game. As mentioned earlier, a player can have more than one identifier in the event where he plays the game more than once. In other words, a player gets more than one identifier when he makes more than one selection. Each selection will offer him a unique identifier. This increases the player's chances of winning the game.

Returning to the example question—“will Apple Stock Price closed above USD500 or below USD500 on the 8 Aug. 2013?”. If the outcome of the event is below USD500, then all the players who made the selection “below USD500” stand a chance to win the game. The winner is identified almost instantaneously by comparing the actually closing price of the stock to his unique identifier. This means that if the closing price is USD450, then the player with the unique identifier 450 wins the game. The present invention obviates the requirement for a further draw to pick a winner from those players who selected the option that represents the winning outcome.

The identifiers may be configured in any way that suits the possible outcomes of the event. Different decimal places (and other formats) may also be provided (this will be described in detail below). Its numbers may also be determined in order to restrict or allow the number of participants in any given game.

In addition to one winner, the system may also provide for the selection of consolation winners. This will be described in detail below.

The following example further illustrates the system and method of playing the game according to an embodiment of the present invention.

### EXAMPLE

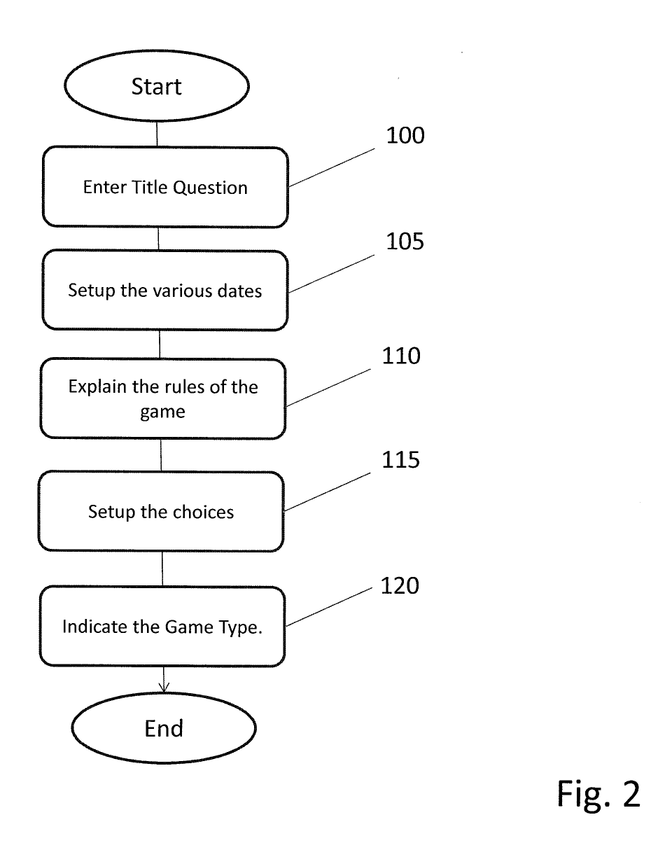

FIG. 2 shows a flow chart showing a summary of the system and method. The organiser of the game will initiate a new game by setting up a new question 100. The question will be one which asks players (i.e. participants to the game) to make a prediction. For example, any one of the following questions may be asked:

1. “What is the close price of Apple stock on the 8 Oct. 2013?”

2. “Who will win the coming France Presidential Election?”

3. “Who will win this Friday Soccer Match?”

The organizer will then set up various dates 105. This allows the organizer to set the starting/closing dates of the game. In an embodiment of the invention, the game may be a contest. As such, the organiser will have to set the start/close dates for players to participate in the competition by answering the question via making a selection. The closing date may be the same as the date for the release of the results of the contest. Since the identifiers are automatically allocated by the system, the system is opened for participation up to the last second before the result is released. Automatic and random assigning of identifiers by the system would also mean that no participant needs to wait until the last minute prior to closing of the contest to make his selection. This means that making the selection early on or later during the contest would have no impact on his chances of winning.

The game may be played in an online internet environment. For example, the game may be offered to players via social network platforms such as Facebook® and the like. In a preferred embodiment, the system may extract profiles of the players, for example profile pictures. The rules of the game will also be explained and provided to players 110. The rules include instructions to participants on how to play the game, including providing information on the “game type” (for example, the total number of winners that will be decided upon) and what the identifiers represent and hence how the winner or winners are identified using the identifiers.

At least two options (or choices) may be provided to each player for the players' selection 115. These options relate to potential outcomes of an event associated with the question asked. With reference to the above three questions, the following options may be available to those questions:

1. “(a) Above USD500, or (b) Below USD500”

2. “(a) Sarkozy, or (b) Hollande”

3. “(a) Chelsea, or (b) Liverpool”

In the above examples, only two options are presented to the players. There may be no limitation to the number of options that may be presented to the players. Upon making a selection, the system will issue an identifier to that player.

Further, the organizer may also indicate the “game type” that may be available to the players:
One Specific Winner Game
One Specific Winner+Consolation Prize winners

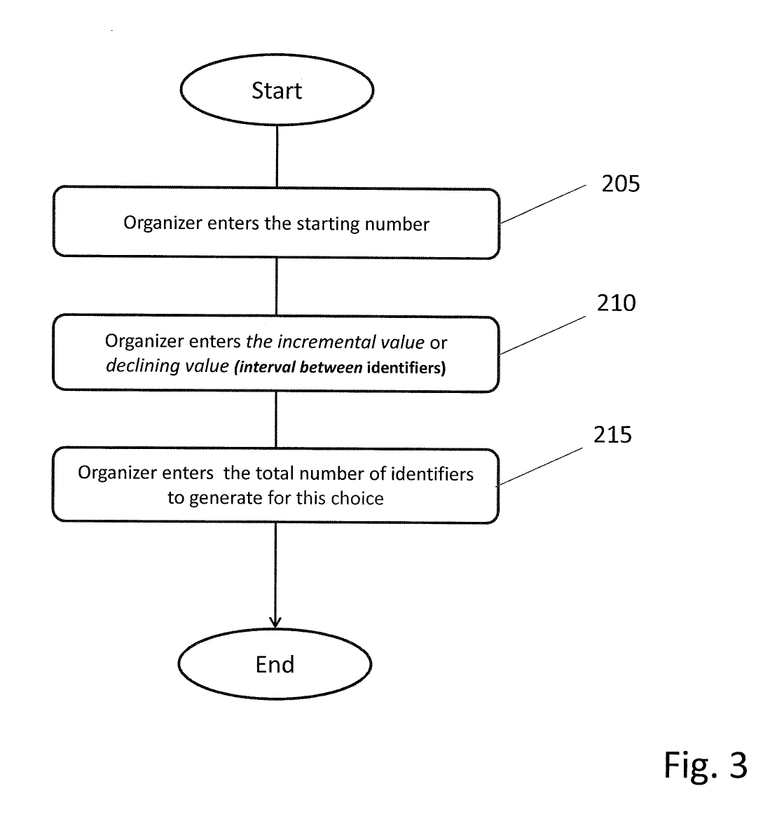

FIG. 3 shows a flow chart to illustrate how an organizer generates the set of identifiers that will be assigned or issued to the player. For each option (possible outcomes) presented to the players, each option will have its respective set of identifiers. As such, for each option, a starting identifier number will first be provided 205 and the order of increment (or decline as the case may be) is then provided 210. The total number of identifiers to generate is also provided 215 and this will result in the generation of the entire set of numbers that will be available to players.

At the start of the game, a player may be asked to sign in at a graphical user interface or web page in an online environment as set up by the organizer. The player may sign up using his mobile phone number or email address, or social media accounts, for example Facebook® account. This allows the organizer to recognize the player and possibly extract certain useful personal particulars of the player, including the player's profile picture.

When an identifier is assigned to a player, the profile picture of the player may be posted in that position in the set of identifiers (in this case, a table of identifiers) at that location where the identifier is placed in the set/table.

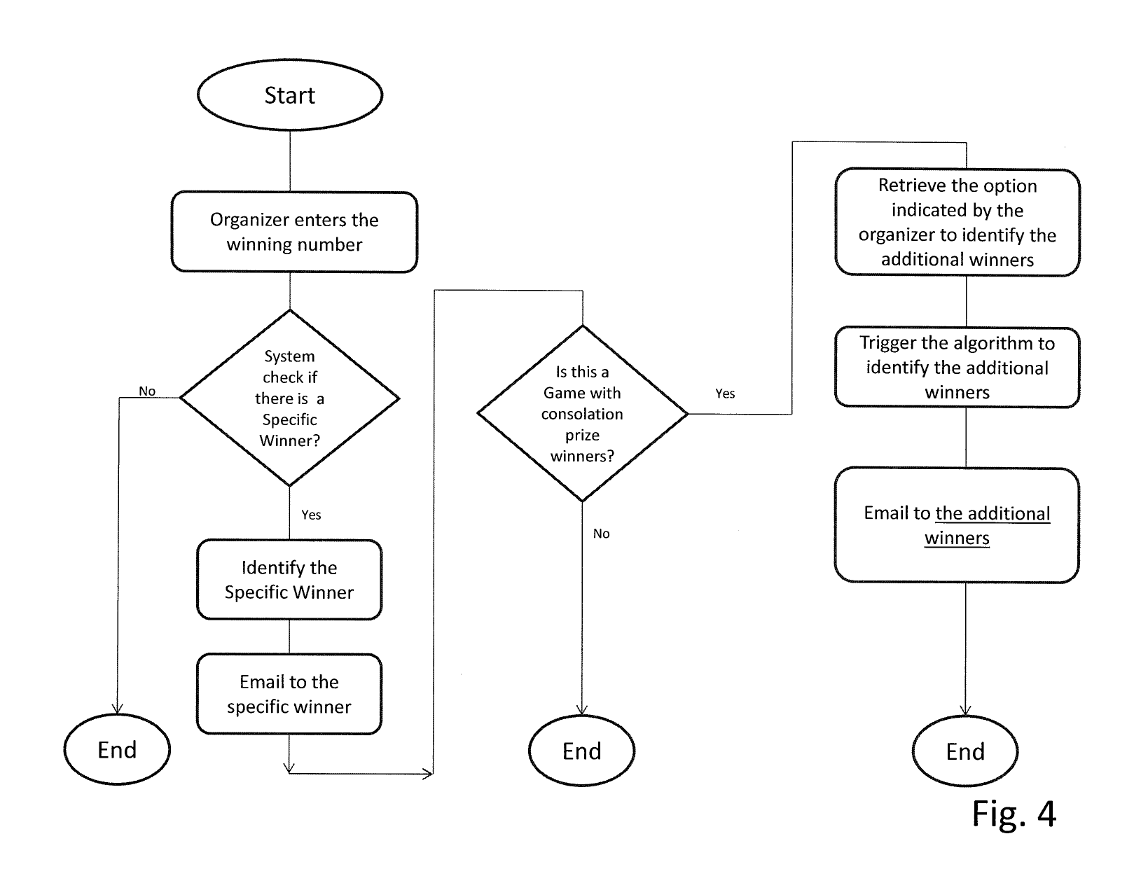

FIG. 4 illustrates how the winner is determined. The set of identifiers represents possible values associated with the outcome of the event. Once the event is over, the identifier that represents the outcome of the event will be the winning identifier. The player with that winning identifier is identified as the winner of the game. This will be further illustrated below.

In an embodiment of the invention, the organizer can manually enter and input the result (for example, the closing price of the stock) into the system. The system will trigger an algorithm to check if there is or are any specific winner by performing the following steps:
(a) Check for the identifier that tallies with the result value entered;
   a. If the identifier has not been issued, then there is no winner in the game,
   b. If the identifier has been issued to a player, then the player who was assigned that identifier wins the game;
(b) An email may be sent to the winner.

The winner or winners may be notified via email. If there are no winners, then no action needs to be taken. There will be no winner if there is no player that was issued that winning identifier.

The system's algorithm will further check if the game allows for additional winners, in particular consolation winners.

Consolation prize winners may be identified with reference to the winner of the game. As the unique identifier may be created automatically by the system via a random algorithm, some players will be allocated an identifier that may have a high chance of winning while others will be allocated an identifier that has little or no chance of winning. For a game to have consolation prize winners, the organiser of the gamer will need to select from a list of possible options, in particular possible patterns on the table of identifiers to identify the additional winners. The at least one consolation winner can be determined by comparing the identifier of the at least one consolation winner with reference to the identifier of the winner. In an embodiment of the invention, since the identifiers may be arranged in a table, the identifier of the at least one consolation winner is proximate to the identifier of the winner in the table of identifiers. By “proximate”, and with reference to the comparison between identifiers of consolation winners and identifiers of the winner, it is meant to include identifiers of the consolation winners that are close to the identifier of the winner.

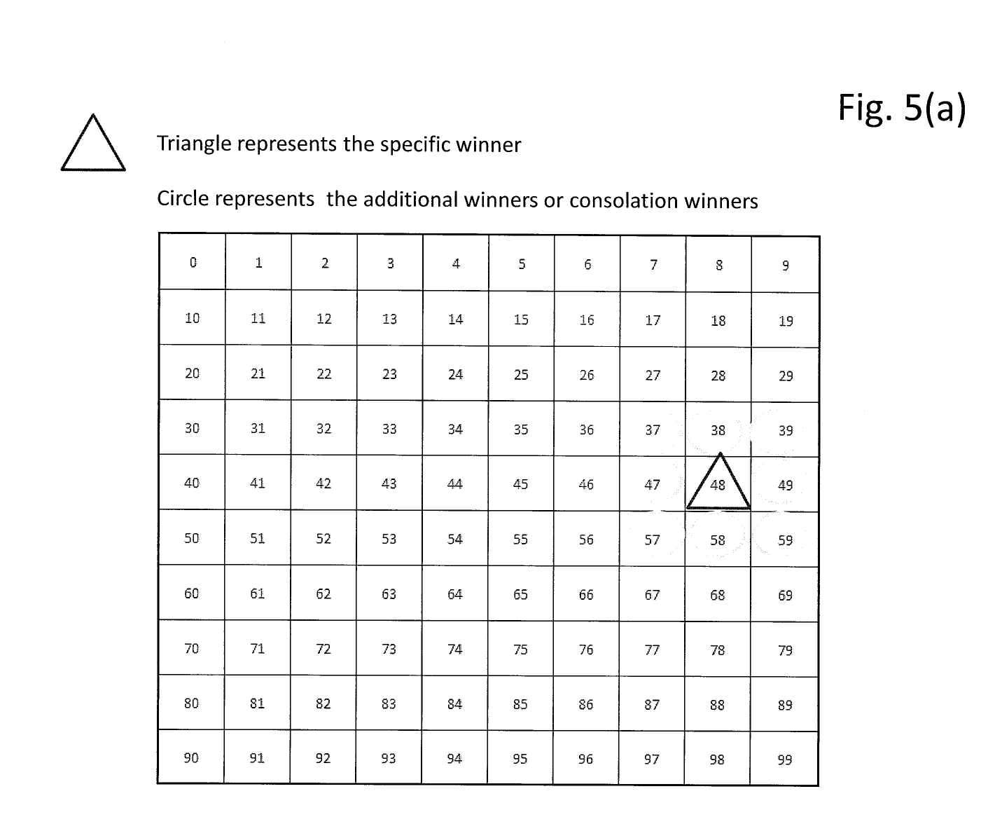

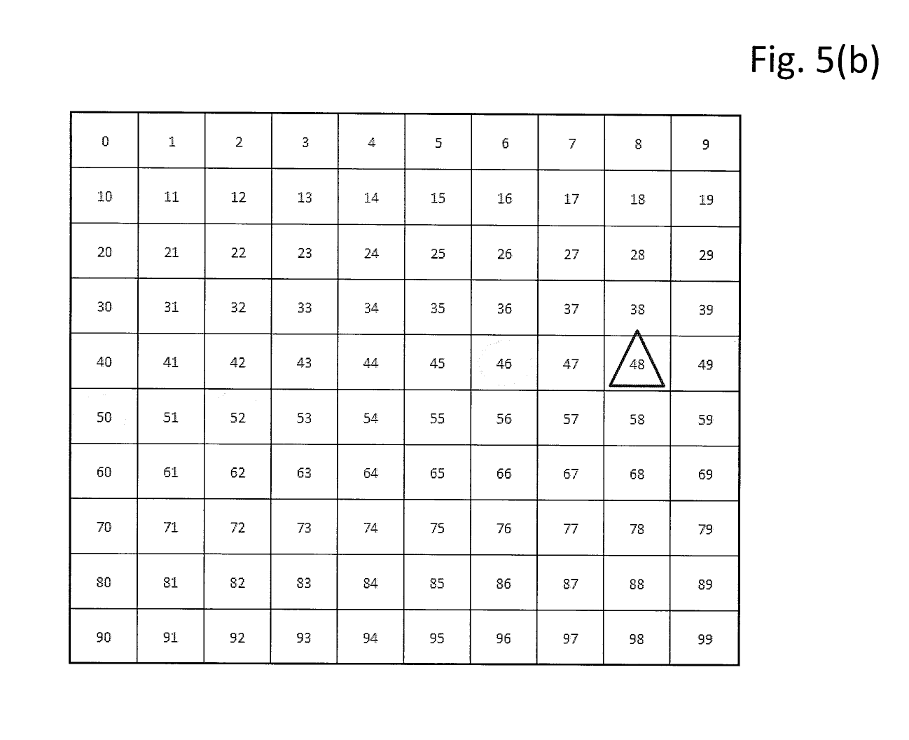

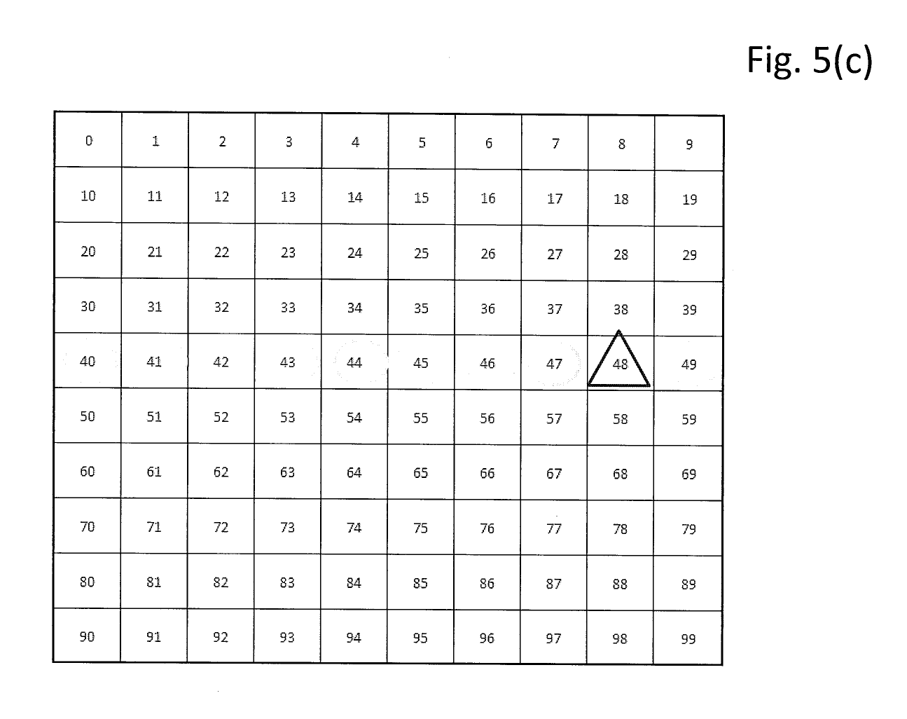

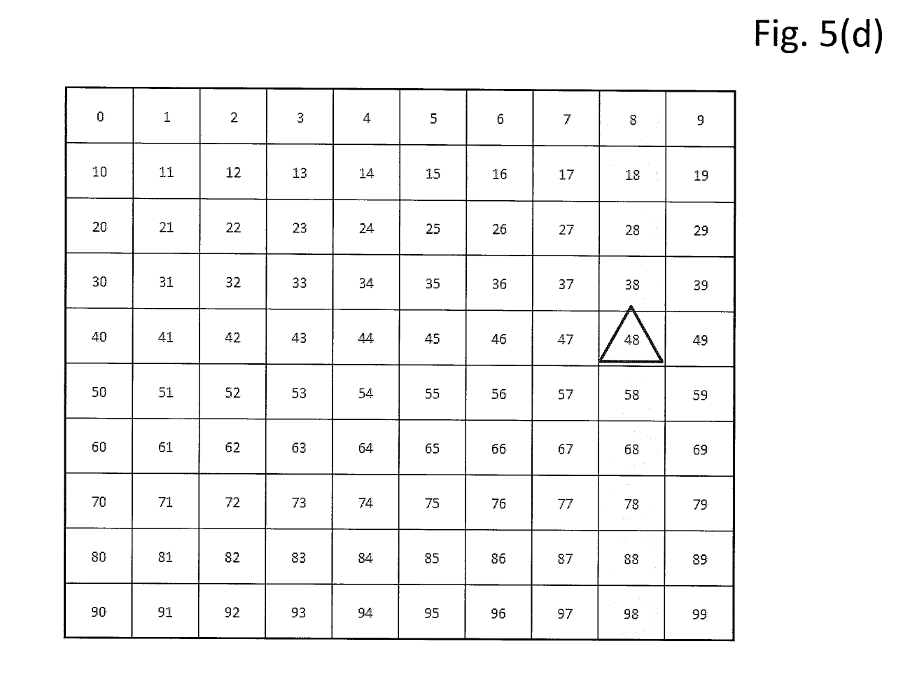

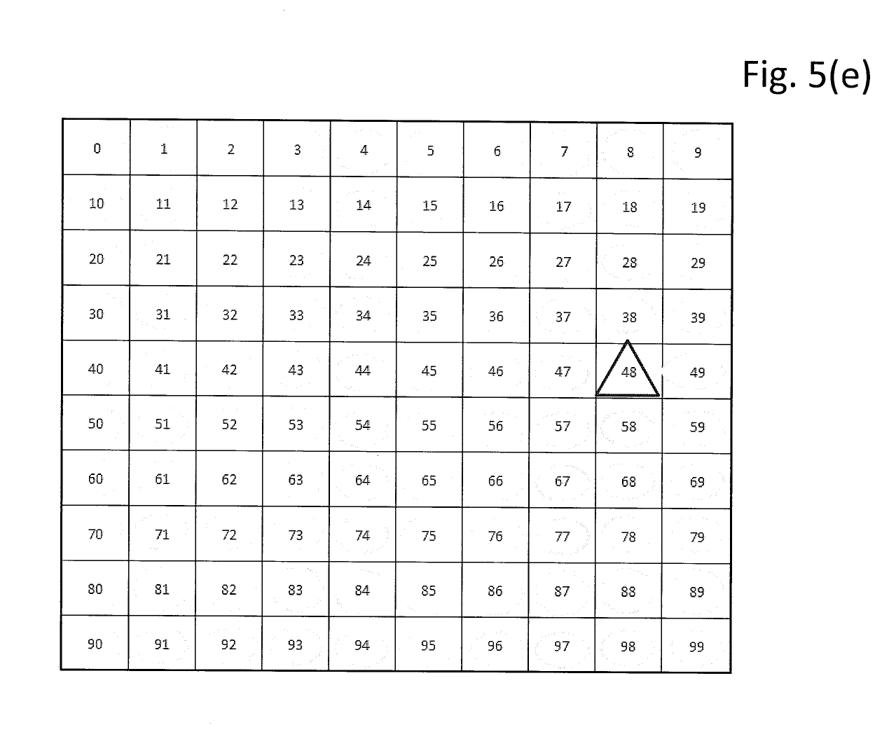

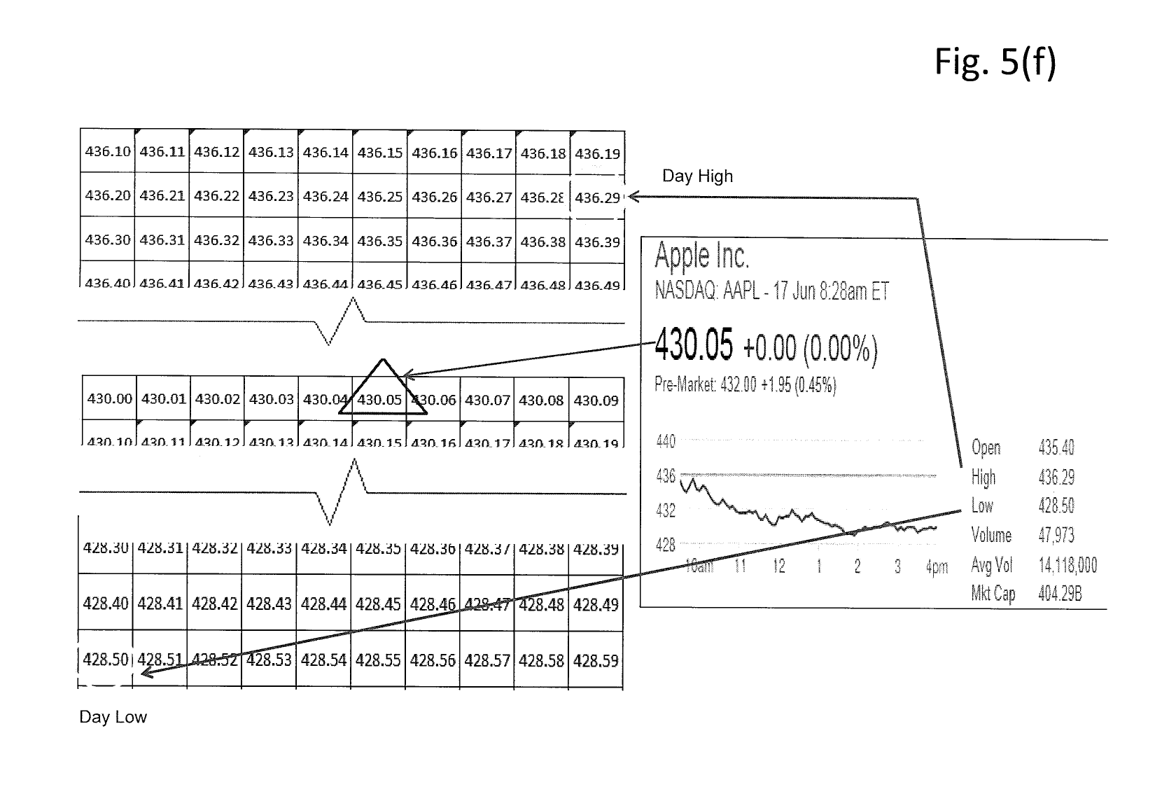

FIGS. 5(a) to (f) show the various examples where consolation prize winners may be identified. In FIG. 5(a), all the identifiers surrounding the winning identifier may be considered the consolation prize winners. In FIG. 5(b), alternate identifiers may be considered the consolation prize winners. Alternatively, as shown in FIG. 5(c) to (e) entire row or column or table may be identified as consolation prize winners. FIG. 5(f) shows a further alternative to the selection and identification of consolation prize winners. In FIG. 5(f), the consolation winners are identified based on the “Day High Closed” value and the “Day Low Closed” value. In this example shown, there are only two consolation winners—the identifier that represents the highest stock price and the identifier that represents the lowest stock price recorded within the day. As such, consolation prize winners can be determined from the start of the game by pre-determining the selection of identifiers that correspond to alternative outcomes of the event. In these examples, additional consolation prize winners may only be identified if there is a winner in the game.

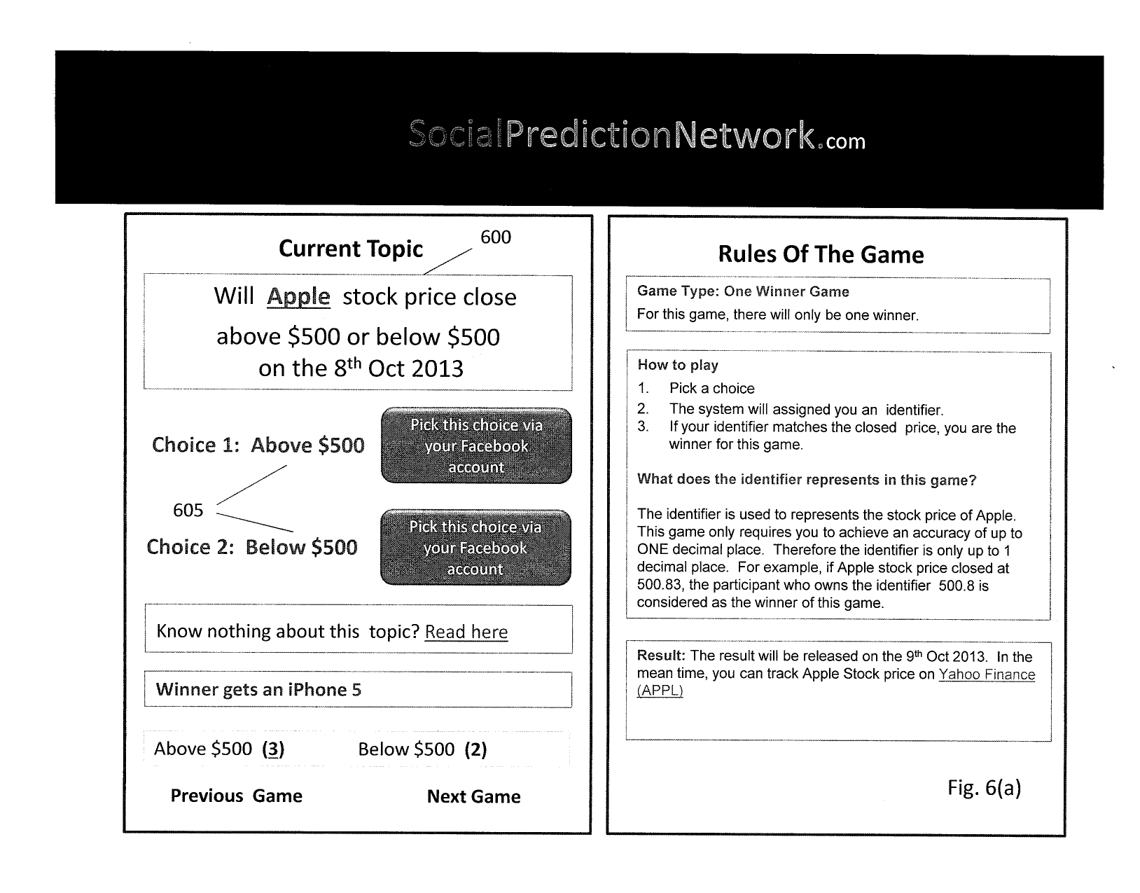

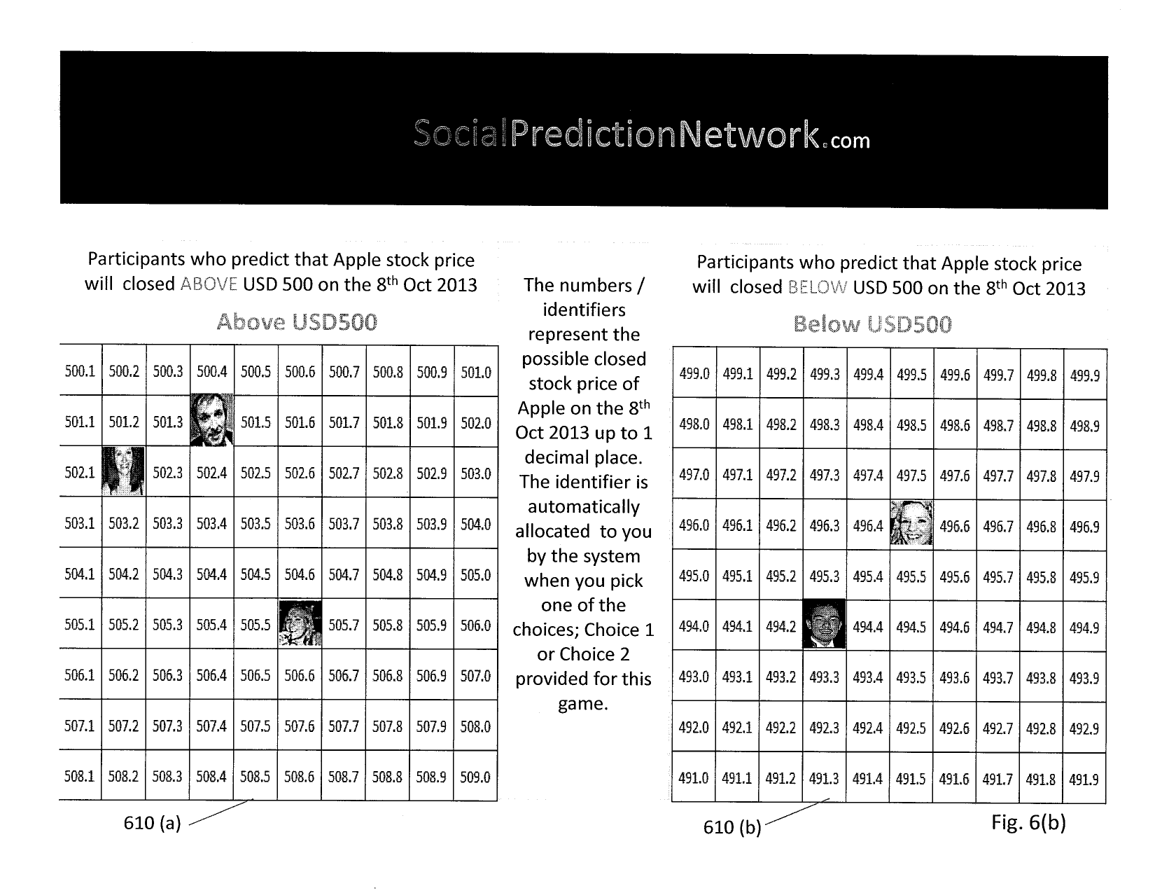

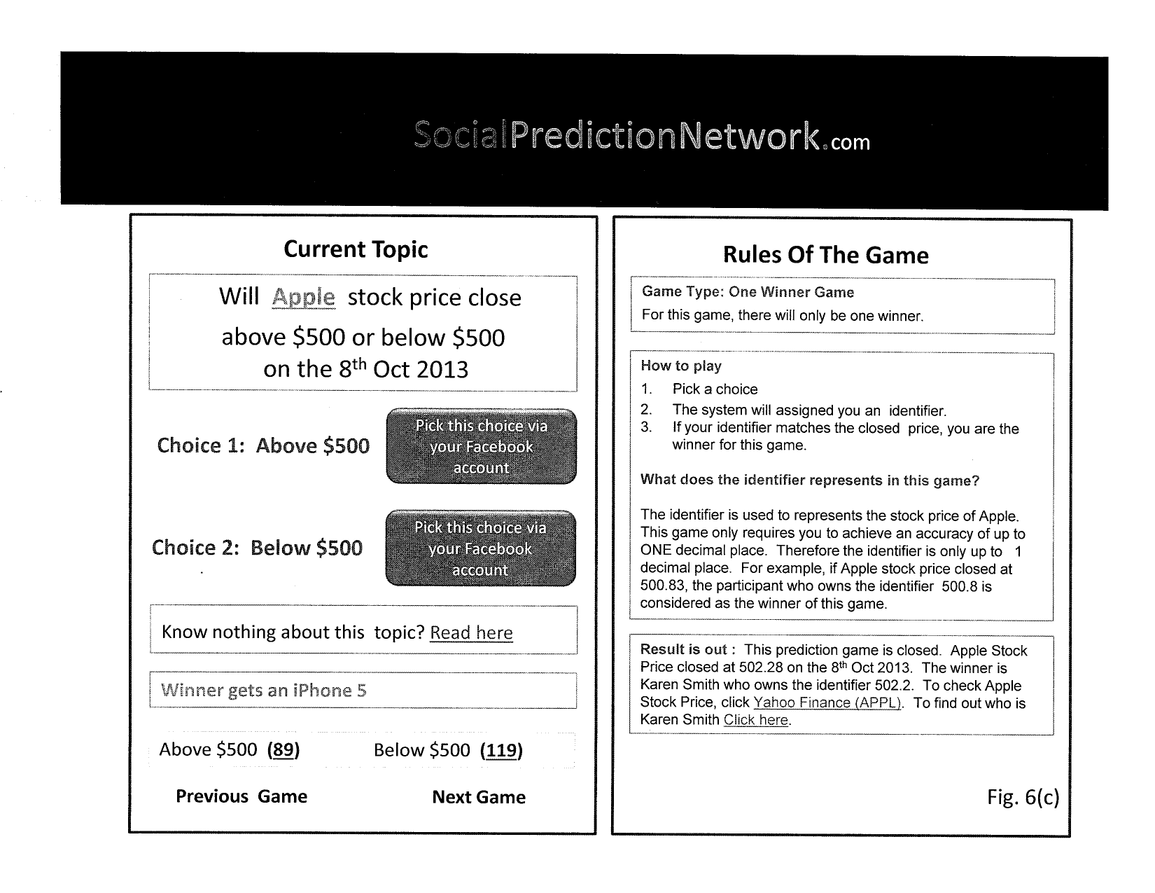

FIGS. 6(a) to (c) show pictorial summaries of an example of a game according to an embodiment of the present invention. The pictorial summaries may be a graphical user interface of the present system. In this example, the prediction question posed to players is “Will Apple Stock Price close above US$500 or below US$500 on the 8 Oct. 2013” 600 and the two options (“above” or “below”) 605 are provided to players for selection. FIG. 6(b) shows the two separate set of identifiers 610a, 610b associated with either option 610(a)/610(b) from which an identifier is issued to each player. FIG. 6(c) shows the identification of the winner.

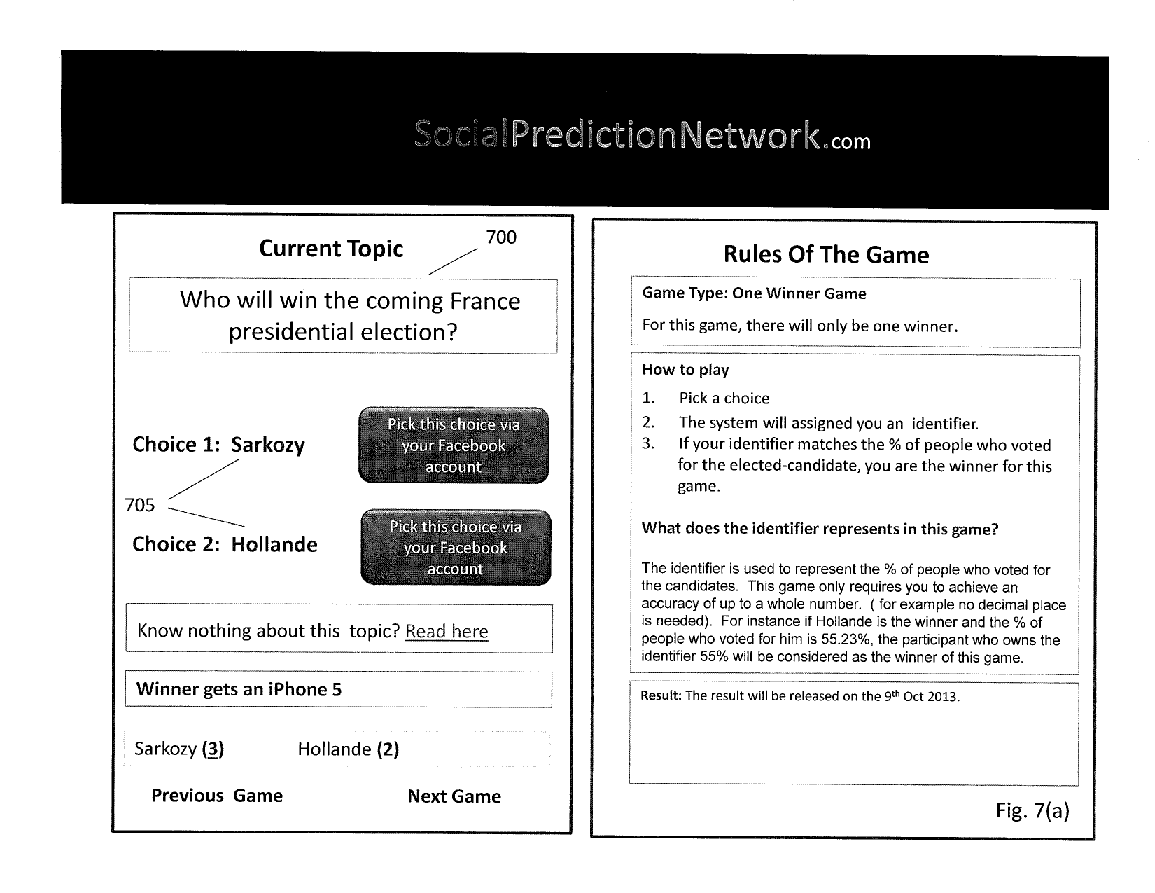

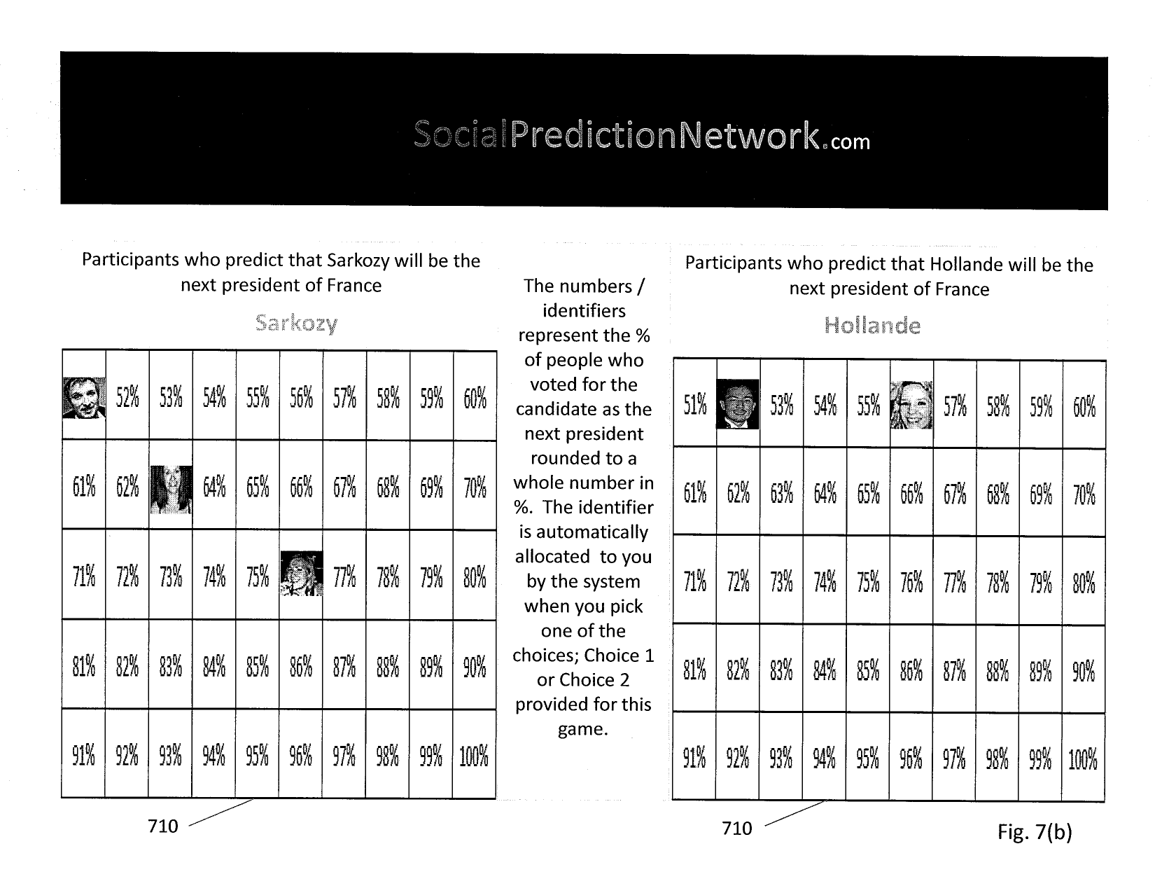

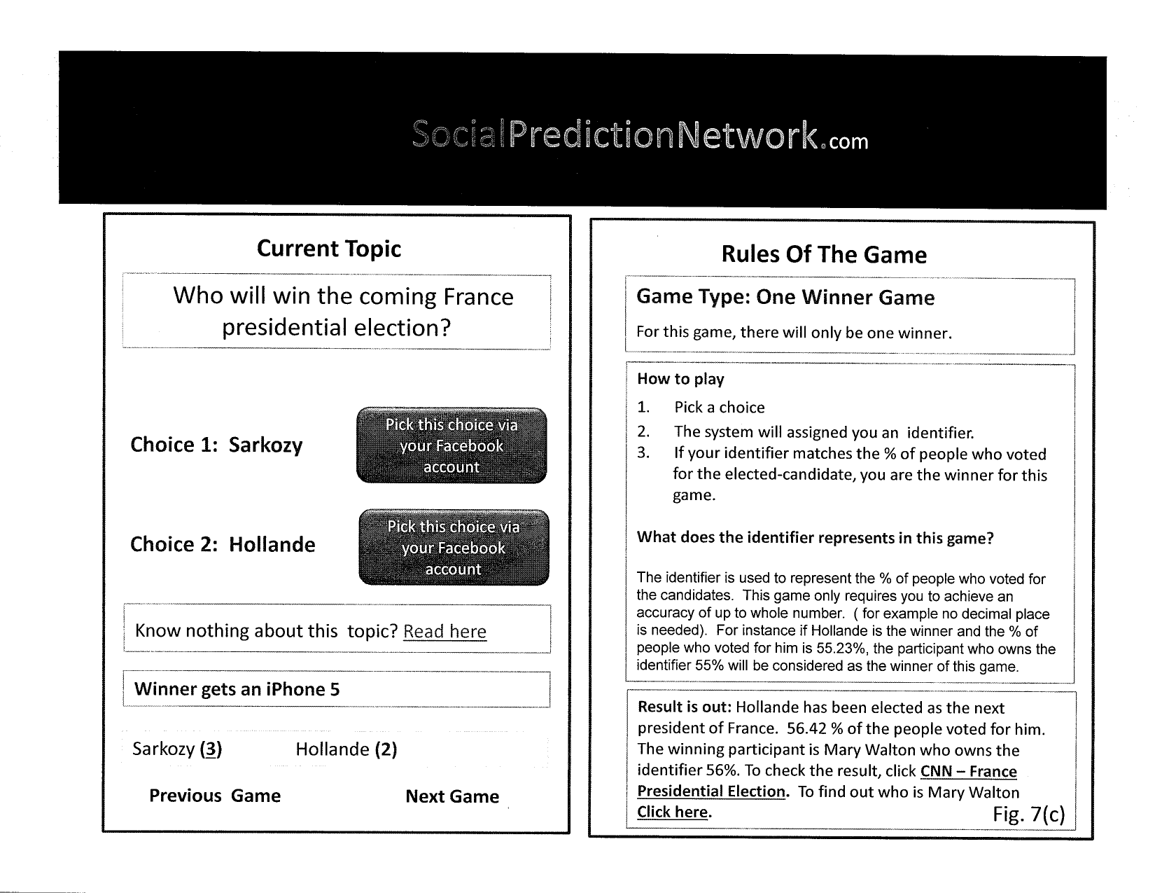

FIGS. 7(a) to (c) show pictorial summaries of an example of a game according to another embodiment of the present invention. The pictorial summaries may be a graphical user interface of the present system. In this example, the prediction question posed to players is “Who will win the coming France presidential elections” 700 and options of Sarkozy and Hollande 705 are provided to players for selection. FIG. 7(b) shows the set of identifiers 710 from which an identifier is issued to each player. FIG. 7(c) shows the identification of the winner.

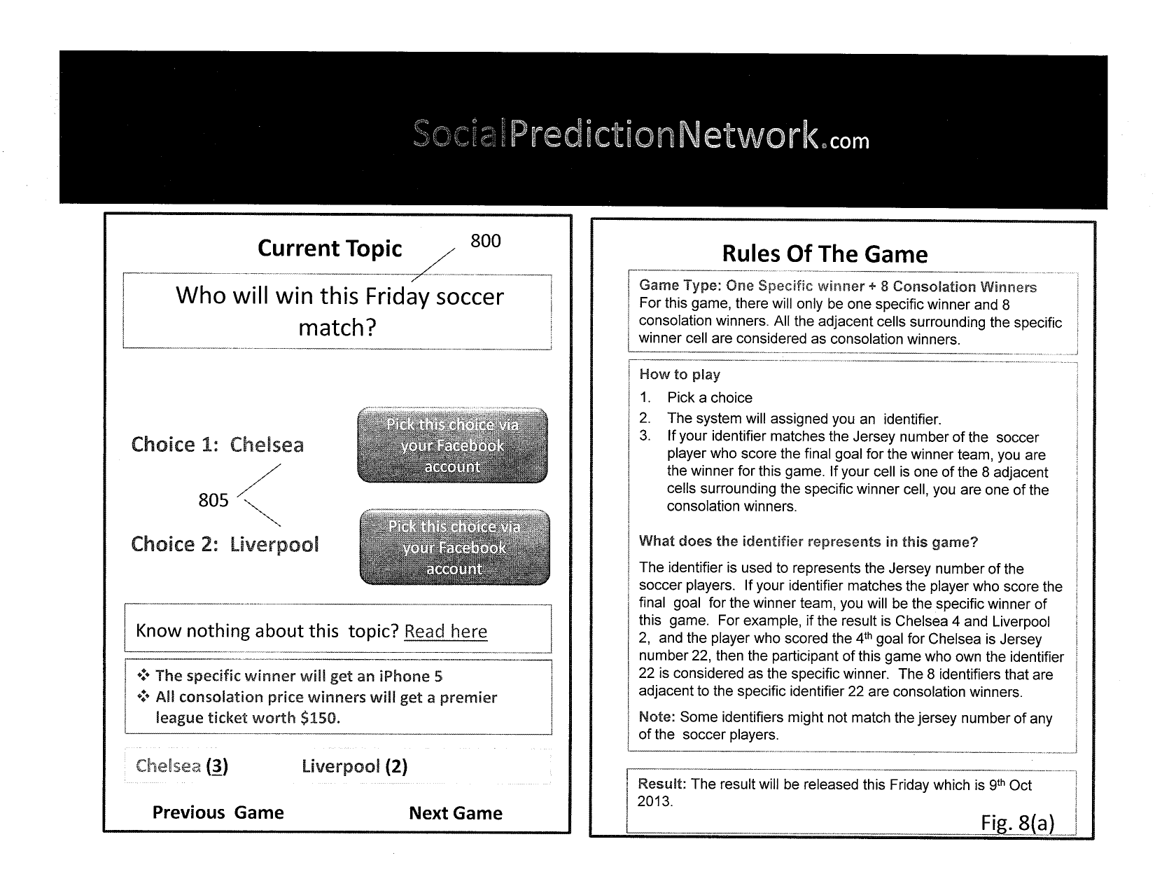

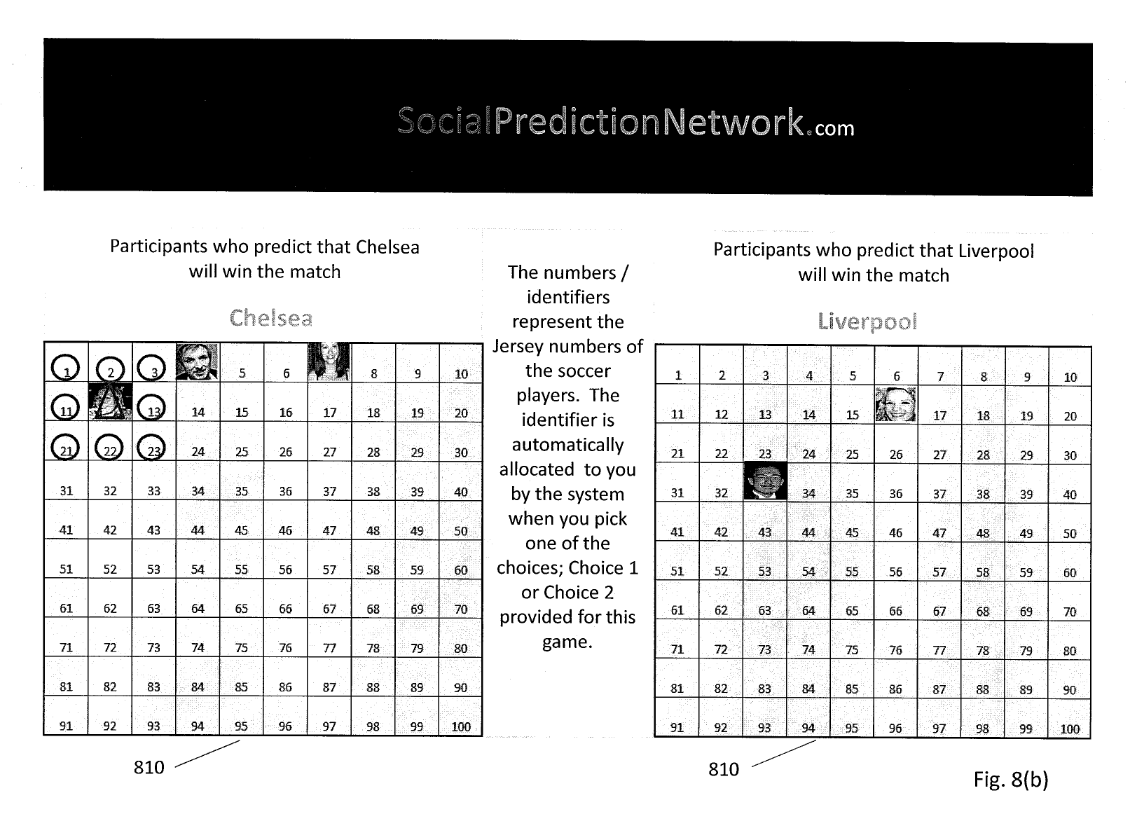

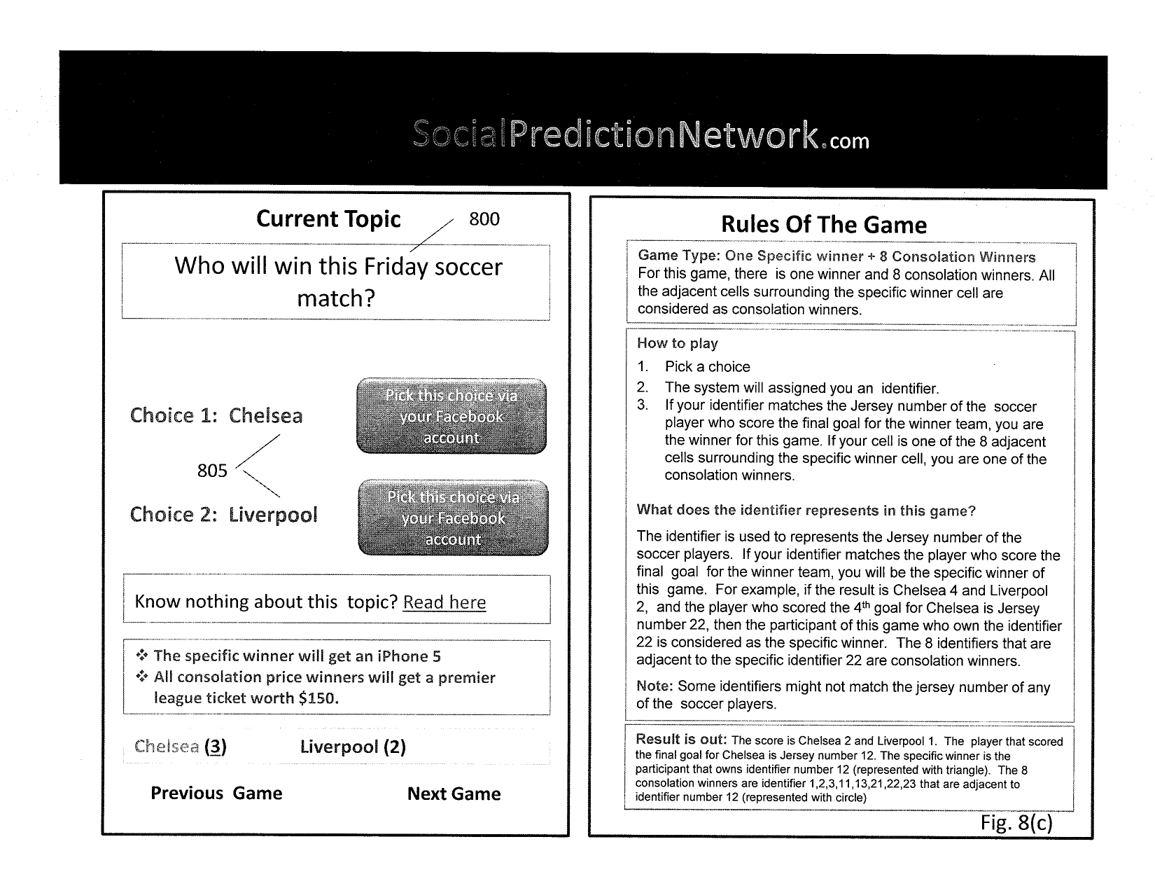

FIGS. 8(a) to (c) show pictorial summaries of an example of a game according to another embodiment of the present invention. The pictorial summaries may be a graphical user interface of the present system. In this example, the prediction question posed to players is “Who will win this Friday Soccer Match?” 800 and options of Chelsea and Liverpool 805 are provided to players for selection. FIG. 8(b) shows the set of identifiers 810 from which an identifier is issued to each player. FIG. 8(c) shows the identification of the winner.

Whilst there has been described in the foregoing description preferred embodiments of the present invention, it will be understood by those skilled in the technology concerned that many variations or modifications in details of design or construction may be made without departing from the present invention.

What is claimed is:

1. A method for playing a game, the method comprising:
(a) Providing at least two options to a player for the player's selection, the at least two options relate to at least two potential outcomes of an event;
(b) Obtaining a selection from the player; and
(c) issuing to the player a unique identifier, the identifier obtained from a set of identifiers representing possible values associated with the outcome of the event; and
(d) Comparing the outcome of the event with the player's identifier to determine if the player is the winner.

2. The method according to claim 1, wherein the unique identifier is randomly issued to the player.

3. The method according claim 1, wherein the set of identifiers comprises a series of identifiers in successive order.

4. The method according to claim 3, wherein the difference between each successive identifier is 1.

5. The method according to claim 3, wherein the difference between each successive identifier is 0.1.

6. The method according to claim 3, wherein the difference between each successive identifier is 0.01.

7. The method according to claim 3, wherein the difference between each successive identifier is 0.25.

8. The method according to claim 3, wherein the difference between each successive identifier is 0.025.

9. The method according to claim 1, wherein the identifiers are arranged in a table consisting of rows and columns.

10. The method according to claim 9, the method further comprising determining at least one consolation winner by comparing the identifier of the at least one consolation winner with reference to the identifier of the winner, wherein the identifier of the at least one consolation winner is proximate to the identifier of the winner in the table of identifiers.

11. The method according to claim 1, wherein the events are selected from any one of the group: ongoing sporting events, political elections, and close prices of stocks.

12. A system for playing a game, the system comprising:
(a) a means for providing at least two options to a player for the player's selection, the at least two options relate to at least two potential outcomes of an event;
(b) a means for obtaining a selection from the player; and
(c) a means for issuing to the player a unique identifier, the identifier obtained from a set of identifiers representing possible values associated with the outcome of the event; and
(d) a means for comparing the outcome of the event with the player's identifier to determine if the player is the winner.

13. The system according to claim 12, wherein the unique identifier is randomly issued to the player.

14. The system according to claim 12, wherein the set of identifiers comprises a series of identifiers in successive order.

15. The system according to claim 14, wherein the difference between each successive identifier is 1.

16. The system according to claim 14, wherein the difference between each successive identifier is 0.1.

17. The system according to claim 14, wherein the difference between each successive identifier is 0.01.

18. The system according to claim 14, wherein the difference between each successive identifier is 0.25.

19. The system according to claim 14, wherein the difference between each successive identifier is 0.025.

20. The system according claim 12, wherein the identifiers are arranged in a table consisting of rows and columns.

21. The system according to claim 20, the system further comprising a means for determining at least one consolation winner by comparing the identifier of the at least one consolation winner with reference to the identifier of the winner, wherein the identifier of the at least one consolation winner is proximate to the identifier of the winner in the table of identifiers.

22. The system according to claim 12, wherein the events are selected from any one of the group: ongoing sporting events, political elections, and close prices of stocks.

23. A computer-readable medium having computer-readable signals stored thereon that define instructions that, as a result of being executed by a computer, instructs the computer to perform a method for playing a game, the method comprising:
(a) Providing at least two options to a player for the player's selection, the at least two options relate to at least two potential outcomes of an event;
(b) Obtaining a selection from the player; and
(c) issuing to the player a unique identifier, the identifier obtained from a set of identifiers representing possible values associated with the outcome of the event; and
(d) Comparing the outcome of the event with the player's identifier to determine if the player is the winner.
